(19) United States
(12) Patent Application Publication
(10) Pub. No.: US 2008/0049990 A1
(43) Pub. Date: Feb. 28, 2008

(54) Automatic Detection of Skin Lesions

(76) Inventors: Carmelo Francesco Melchi, Roma (IT); Oscar Bellerino, Roma (IT)

Correspondence Address: YOUNG & THOMPSON, 745 SOUTH 23RD STREET, 2ND FLOOR, ARLINGTON, VA, 22202, US

(21) Appl. No.: 10/553,996

(22) PCT Filed: Apr. 15, 2004
(86) PCT No.: PCT/IT04/00217

§ 371 Date: Mar. 2, 2007

(30) Foreign Application Priority Data
Apr. 22, 2003 (IT) RM2003A000184

(51) Int. Cl. G06K 9/00

(52) U.S. Cl. 382/128; 600/300

(57) ABSTRACT

The method collects digital images of the body surface of the tested subject after having divided the latter into one or more areas exactly located by spatial coordinates in a system of coordinated axes fixed with respect to predetermined unchanged reference points of the subject. The images are stored in a suitable data base to be then compared automatically with corresponding images collected at distance of time, thus producing a signal of any variation in the number and/or the morphology/color of the lesions.

The present invention relates to the secondary prophylaxis of a neoplasm which originates from the dermal pigmentary system as well as the follow-up of the inflammatory and/or degenerative skin diseases, and particularly, a method that shows automatically and eventually any variation in the number and/or morphology of skin lesions of the patient by the automated detection of the state of the skin surface of the patient in following tests and the comparison of the last detection with the preceding one.

Another object of the present invention is an apparatus for carrying out the method. This in order to draw the physician's attention to all and only the skin lesions with dermatological concern, such as nevus, psoriasis, vitiligo, tumours and/or dermal lymphomas, etc, which must be checked by the physician himself. To this end, it should be appreciated that frequent reference is made hereinafter to nevus, however, this has not to be intended as limitative because this invention can be applied, without modifications, to any type of dermal lesions with dermatological concern.

Dermal melanoma is a malignant neoplasm that originates from the pigmentary cells (melanocytes) of epidermis. Its incidence in Italy inferred from the tumour registers varies according to age: 5.04 out of one hundred thousand inhabitants up to 44 years old, 27.3 out of one hundred thousand inhabitants between 65 and 77 years old.

The risk factors singled out for the onset of the disease come from: genetics (familial melanoma, dysplastic nevus syndrome, xeroderma pigmentosus); phenotypes (colour of eyes, colour of hair, phototype, lentigines, number of common nevi, number of atypical nevi); environment (ultraviolet radiations, solar radiations, pesticides, environmental polluting agents).

Evidences has been found that most melanomas do not arise from nevus cells, and although the disease nature history is not well known the development of neoplasm is suspected of being biphasic: after a relative quick growth the melanoma can remain stable as for morphology and growth also for many years. In this phase both physician and patient can hardly suspect its presence as its aspect is not different from an ordinary nevus; quick changes leading usually to the excision of the skin lesion and its histological test would set in only tardily.

The disease prognosis is entirely bound to the thickness of the neoplasm upon its ablation: a survival of 10 years is expected in 98 percent of cases if the thickness is not greater than 0.4 mm, and 10 percent if the thickness is greater than 1.5 mm.

Therefore, the fact that every effort has been made to come to an early diagnose of such disease is not astonishing.

One paradigm of medicine is the diagnosis of the disease as deviation from the normality: therefore, the delineation of structure and function of a sound human organism (normal human anatomy and physiology) is primary for individuating and cataloguing states of alteration (pathologies).

However, the definition of the typical morphology of a benignant melanocytic nevus is very hard: in fact their variability is huge. Dimension, colour, contour, axes of symmetry can show quite unlike characteristics both in the same and different individuals. Furthermore, it's now a sure thing that there is no relation between macroscopic and histological aspects of a nevus: signs of dysplasia can be noted both in morphological atypical nevi and the so-called ordinary nevi which are clinically reassuring.

In addition, melanomas ablated fortuitously or not suspected in advance are described as lesions of the morphology quite similar to nevi or, in contrast, quite different from the pigmentary structures.

The definition of a boundary line between benignant nevi and initial malignant melanomas by exclusively clinic criteria is then a hazardous practice having poor scientific character. In such a situation it is easy to understand that physicians turn preferably to the excision-biopsy of lesions with irregular aspect (according to at least one of the following criteria: A=asymmetry; B=irregular contour; C=variegated colour; D=dimension greater than 5 mm), above all those whose natural history, i.e. date of onset, evolution, stability of the morphological characteristics in time, cannot be reconstructed.

One way of allowing physicians to increase their capability of diagnosing initial melanoma is to monitor subjects exposed to the risk through a photographic check of the pigmented lesions. Another approach is to discriminate nevi and melanomas by using the technology of the digital image analysis (digital epiluminescence).

The self-test of the skin to detect abnormalities or changes plays an important role in the early diagnose of melanoma [1, 2].

The effectiveness of such practice is conditioned, however, by the information service to people about the risk “melanoma”, individual socio-economic conditions, and localization of the neoplasm.

Epidemiological, experimental studies [3, 4] showed that also careful subjects looking after changes in the dermal state have high difficulties to detect variations in the aspect of the pigmentary lesions, above all because the recollection of the morphology of their own nevi becomes confused and fragmentary with time.

The practice of monitoring subjects exposed to the risk melanoma through the manual collection of photographic documentation of the whole body or lesions suspected of neoplasm is largely in use by dermatologists. In fact it has been proved that the discovery of initial melanomas is made in subjects exposed to a high risk and checked by physicians who use photographic means to be certain of the morphological stability of patients' lesions to the greatest extent and more easily than in subjects who are only checked by a simple clinic skin test.

The photographic check modes are miscellaneous: analogue cameras, digital cameras, digital image collection and storage systems such as those known on the market and in literature by the following names: “Dermagraphix”, “Mole Max II”, Catia (Computer-Aided Topodermatographic Image Analysis); some of the latter apparatus are also able to carry out tests of single lesions by epiluminescence. The staff involved may be various: physicians, technicians, hospital attendants, professional photographers.

It should be noted, however, that the comparison of the images collected later on is made by the specialist at sight and on the base of his experience to consider any significant modification of the morphologic characteristics of the monitored lesions. The limitations of such practice are not well known. However, it is certain that a standardization of the image collection modes (lighting system, angle shot, shot distance, characteristics of the photographic apparatus used in the different sessions, modes of dividing the photographed body portions) increases the effectiveness of the check method.

Furthermore, the visual comparison of images of pigmented lesions in multi-nevus subjects is particularly hard and expensive.

All of the available technologies for the light sources that can be used (visible light; coherent light; polarized light; interferometry; fluorescence; epiluminescence) have been taken into consideration to identify known concordant reference points relative to the analytical data resulting from the different methods used.

Such considerations and the possible consequences of the use of the different light sources to the operating functionality of the invention brought to the conclusion of implementing an apparatus that uses stable, normalized visible light.

An analytical inquiry into known apparatus aiming at the same purpose as the present invention, in particular methods of digital analysis, methods of image analysis, as well as availability of tools that can be used for the invention, brought only to systems using the epiluminescence technique to detect the malignancy or not of single lesions suspected by the clinic test.

The study of systems for collecting three-dimensional digital images induced the present inventors to reject the use of such methods in the present invention because of the high increase in the difficulty of operation in comparison with the short advantages that could be achieved.

The medical literature teaches essentially that:
subjects with more than 50 nevi run the risk of melanoma onset and often have also pigmented lesions due to sunburns (solar freckles) as well as other skin lesions not of melanocytic origin;
melanoma is associated with a pre-existent nevus only in 15% of case, the remaining 85% arising on formerly uninjured skin;
the modifications of only colour characteristics of a pre-existent lesion can give the premature signal of a canceration in progress;
the melanocytic nature of a pigmented lesion with a diameter lower than 2 mm is clinically uncertain.

As a result, the detection of the onset of a new pigmentary lesion with a diameter of at least 2 mm and/or the increase in the diameter of one or more pre-existent nevi by at least one mm and/or the variation of their morphology/colour in people exposed to the risk of melanoma are very useful data inducing the patients to be subjected to early diagnostic instrumental tests (epiluminescence) or nature tests (histological sampling), thus achieving prognostic advantages in case of positive result (onset of melanoma).

The main object of the present invention is then to provide a method and a relative apparatus able to detect and to show eventual modifications in the number and the morphology/colour of skin lesions of patients in a few dozens of minutes in a simple, reliable, fully automatic manner.

After a thorough analysis of the known technique, a simple USA instrument having three evident purposes has been found on the market, and namely:

1. mapping the nevi in defined areas (counting and numbering them);

2. giving the physician a regular, complete picture of the examined subject's skin;

3. filing general data along with data pointed out by the physician during the visit together with a specialist of video image collection who takes the macro shot of a determined (suspected) nevus falling into a particular quadrant.

Upon the next check, the USA apparatus counts the nevi again and finds new ones, if they appear (however, the minimum dimension threshold is not defined).

The specialist of video image collection takes then a new macro shot of the nevus or nevi under control for the next analysis by the physician so that the system only allows a visual comparison between the preceding and the present states of the nevus or nevi and not an automatic graphic comparison between two images of the same or more nevi detected in subsequent times.

However, such system does not fully satisfy the present needs of monitoring and quickly detecting any anomaly or suspected skin lesion. In fact, it cannot check the growth of any clinically insignificant nevus.

Although on one side the performance of this known apparatus is encouraging as it gives evidences of the arisen nevi and compares two images of the same suspected nevus taken with a time interval from each other, on the other side, it is necessary to consider its high operating cost as the presence of a specialist of video image collection to take the macro shot is needed. In addition, it is not possible to automatically detect clinically little evident initial growth or those most significant for a better prognosis.

A second object of the present invention is to overcome the limits mentioned above and to keep the advantages.

A third object of the invention is to provide a system capable of collecting standardized digital images of the whole body and/or a single lesion; to compare automatically the digital images of the same body segment of the same patient detected in subsequent times and then to show to the operator—who should not necessarily be a physician or a specialist of video image collection—modifications of the pre-existent lesions of the body or the onset of a new lesion; and to weigh statistically the probability that the detected modifications can be effective or depending on little random modifications of the mode of detection.

The advantages of the invention are connected to the capability for the digital image analysis of: highlighting structure, dimension or contour modifications of the pigmented lesions monitored by greater reproducibility and precision than the visual comparison; reducing time and cost necessary to compare the aspect in time of each single pigmentary lesion in multi-nevus subjects; giving the tested subject a base documentation of his or her pigmented lesions that can be easily consulted for a more effective self-check.

This has been accomplished according to the invention by providing an automated apparatus that collects and compares the following parameters in order to compare images of the same subject collected in subsequent times to highlight automatically any morphology/colour difference of the lesions under control:
number of known nevi/number of detected nevi;
minimum nevus dimensions that can be detected equal to 3 mm²;
minimum nevus dimension modifications that can be detected equal to 1 mm.

A better understanding of the invention will follow from the following detailed description with reference to the accompanying drawings that show by way of a not limited example a preferred embodiment thereof.

In the drawings:

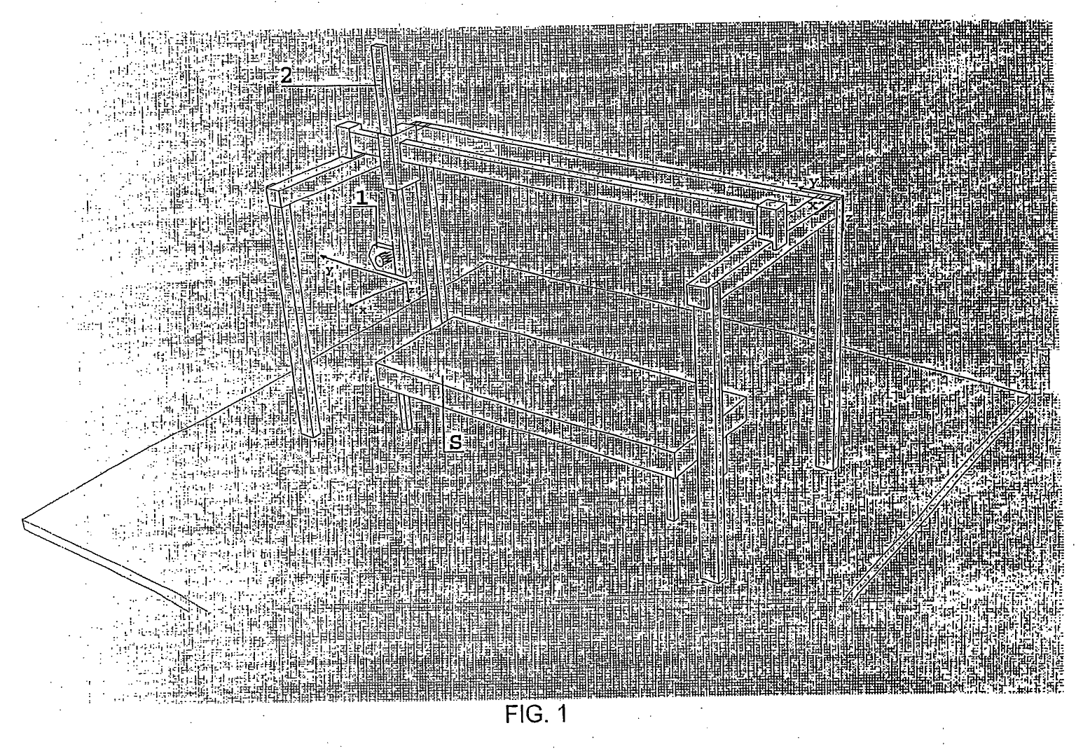

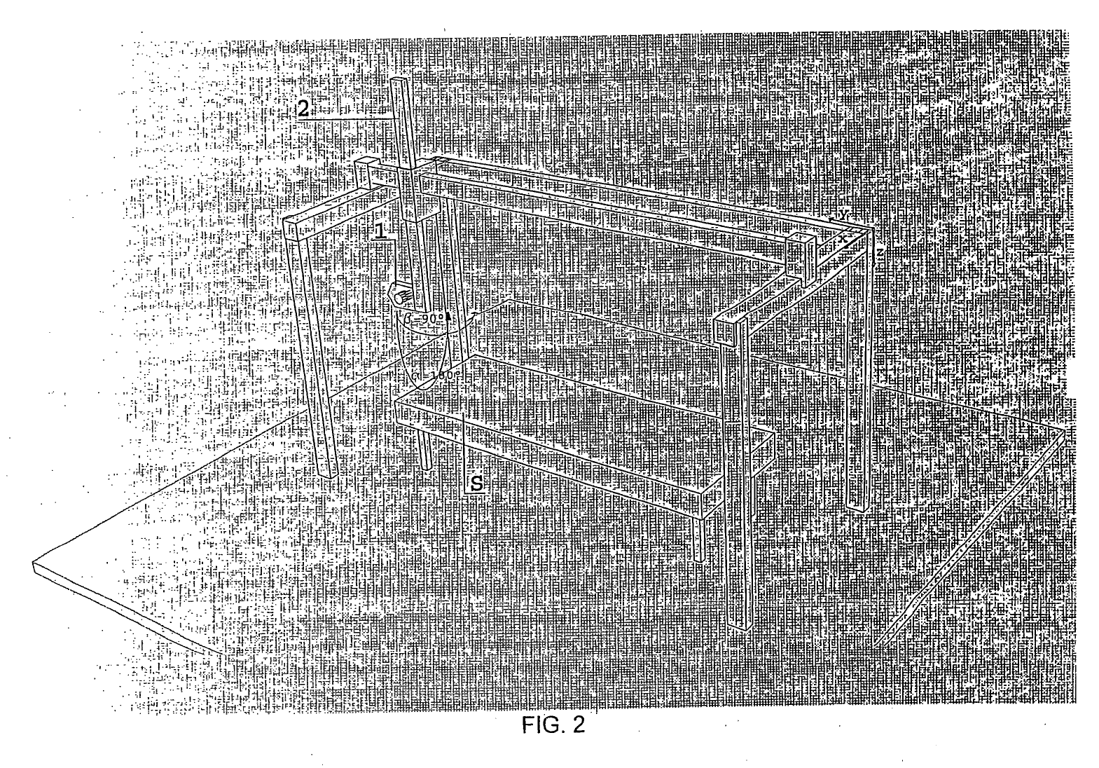

FIGS. 1 and 2 are two axonometric views of the structure of the apparatus showing schematically the arrangement of the reference axes and the relative rotation angles of the image collection means, respectively;

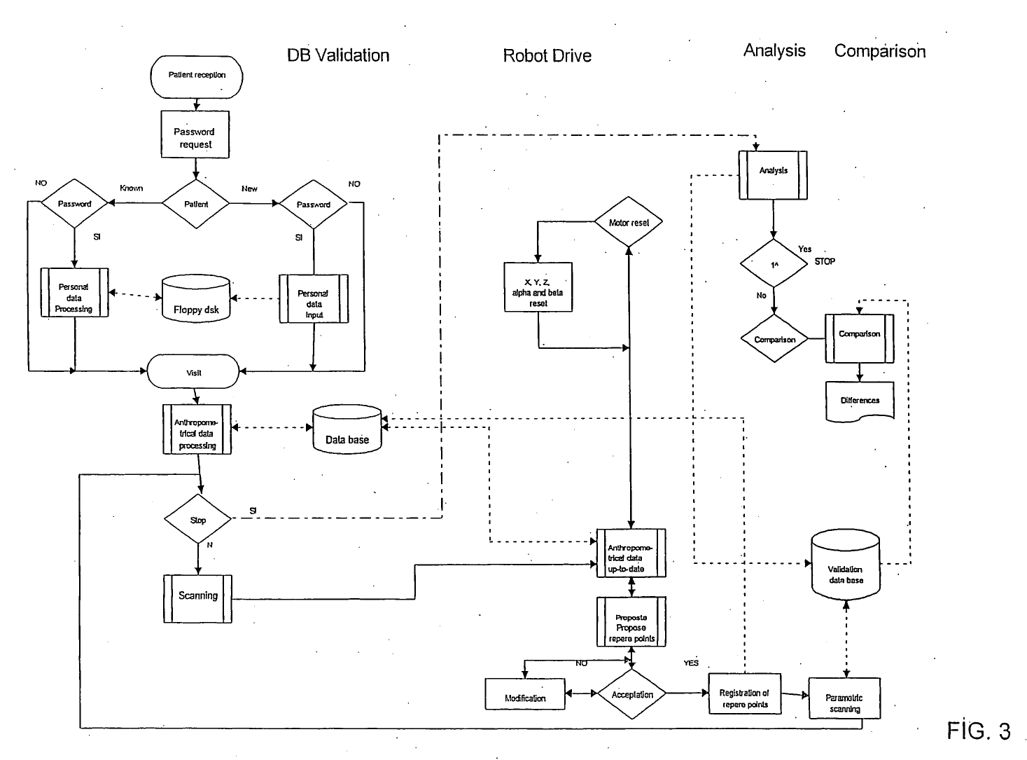

FIG. 3 is a logical functional block diagram of the apparatus according to the invention;

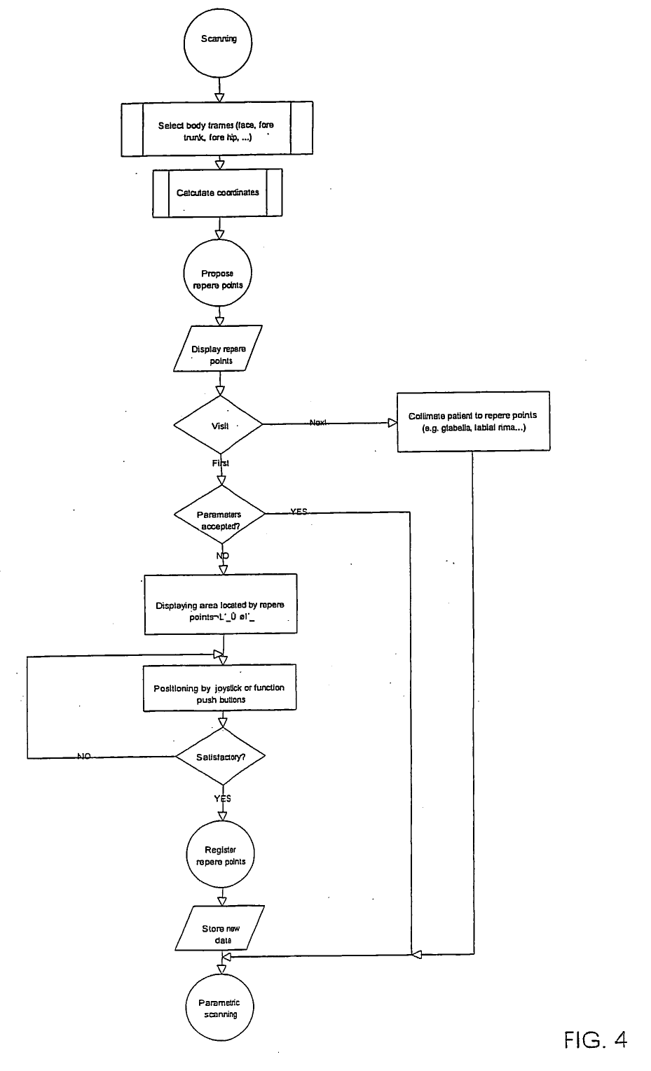

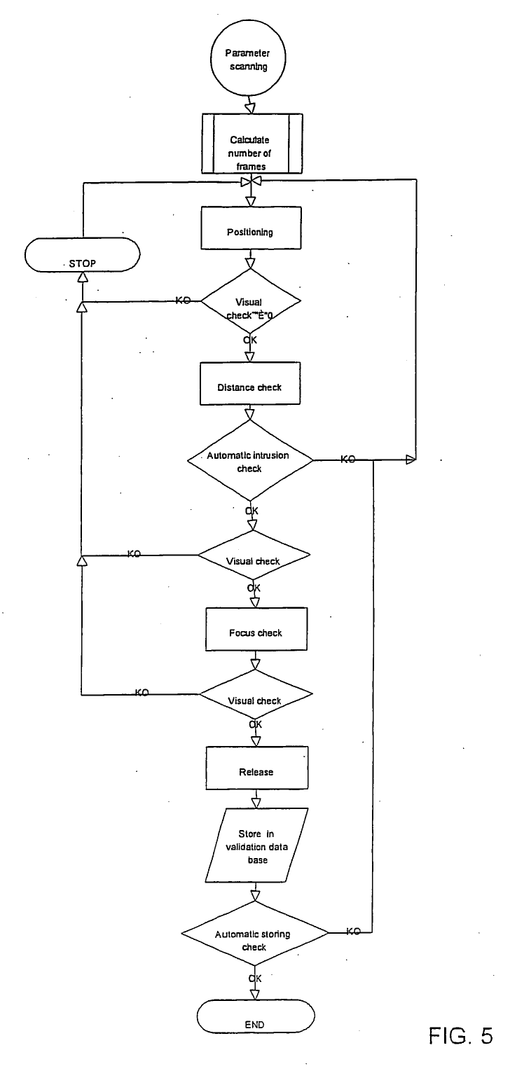

FIGS. 4 and 5 are block diagrams relative to the scanning operation (i.e. transfer of processed input data) as well as scanning of parameters of FIG. 3;

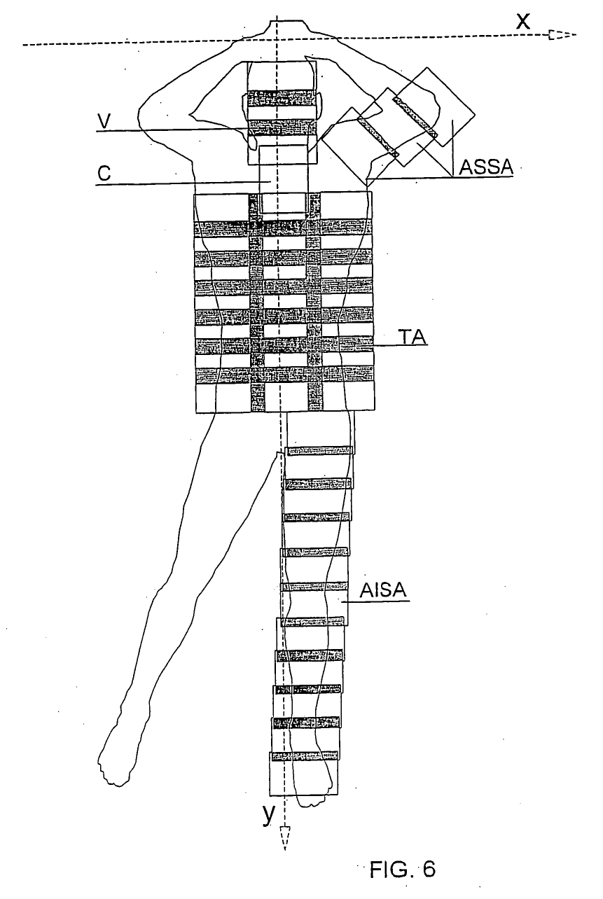

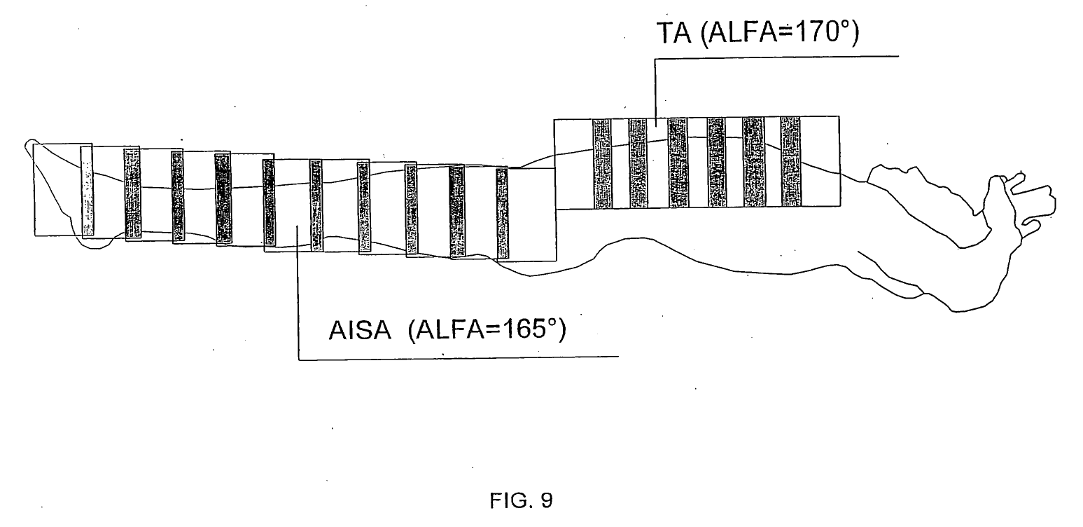

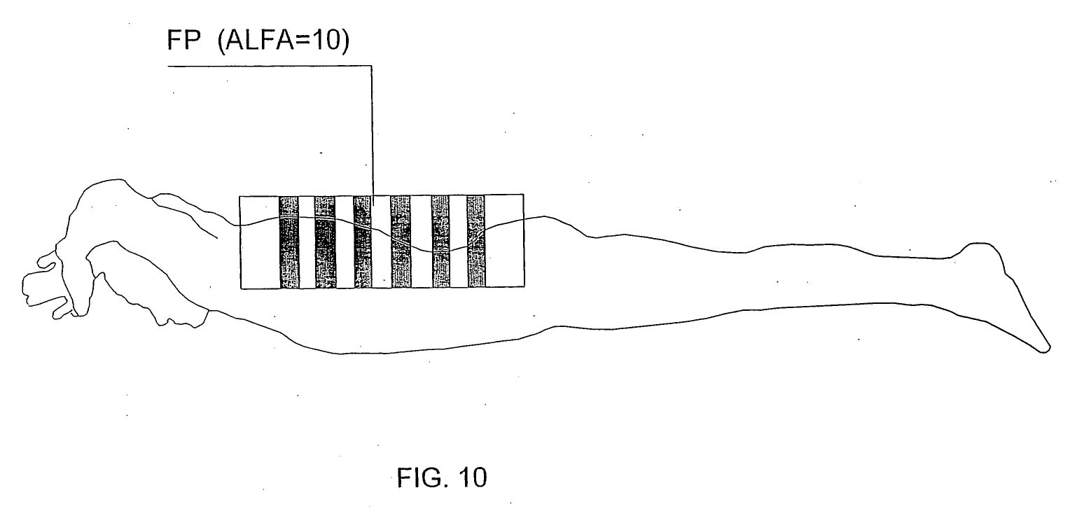

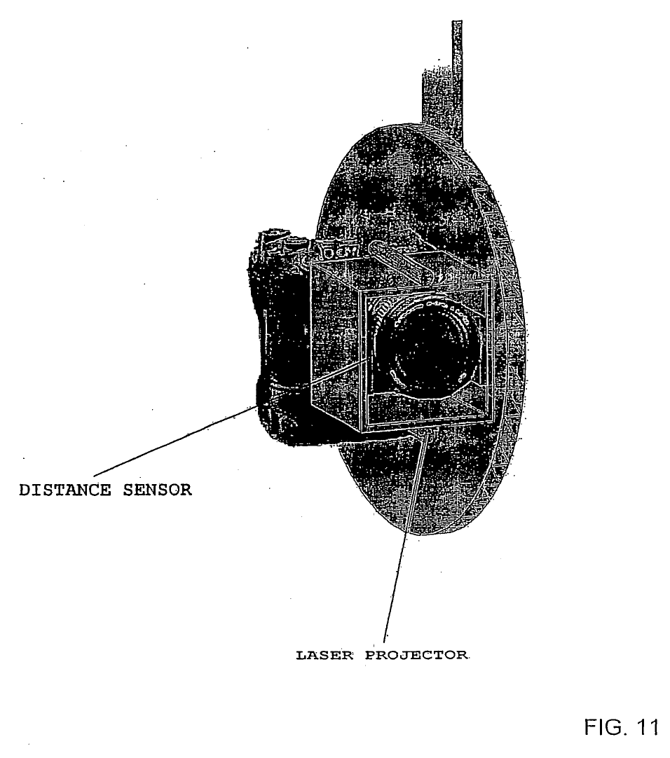

FIGS. 6, 9 and 10 show by way of example the positions of the frames with respect to the body of the patient;

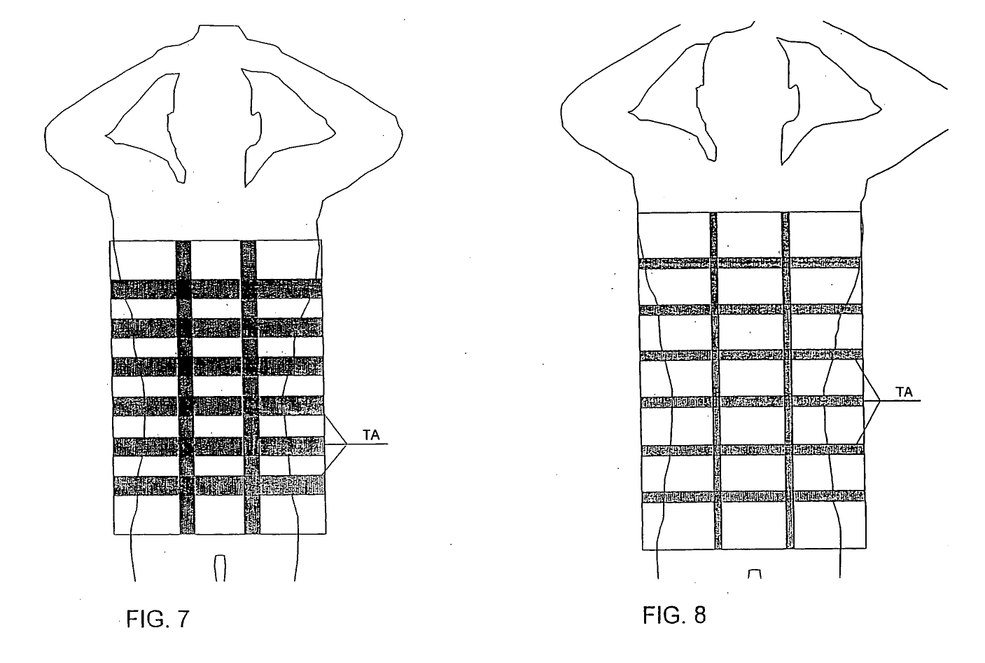

FIGS. 7 and 8 show an example of the variation of a frame image overlap in case of a dimension modification (increase) with respect to the preceding session;

FIG. 11 shows schematically an example of an image collection apparatus provided with distance sensors and laser beam projector;

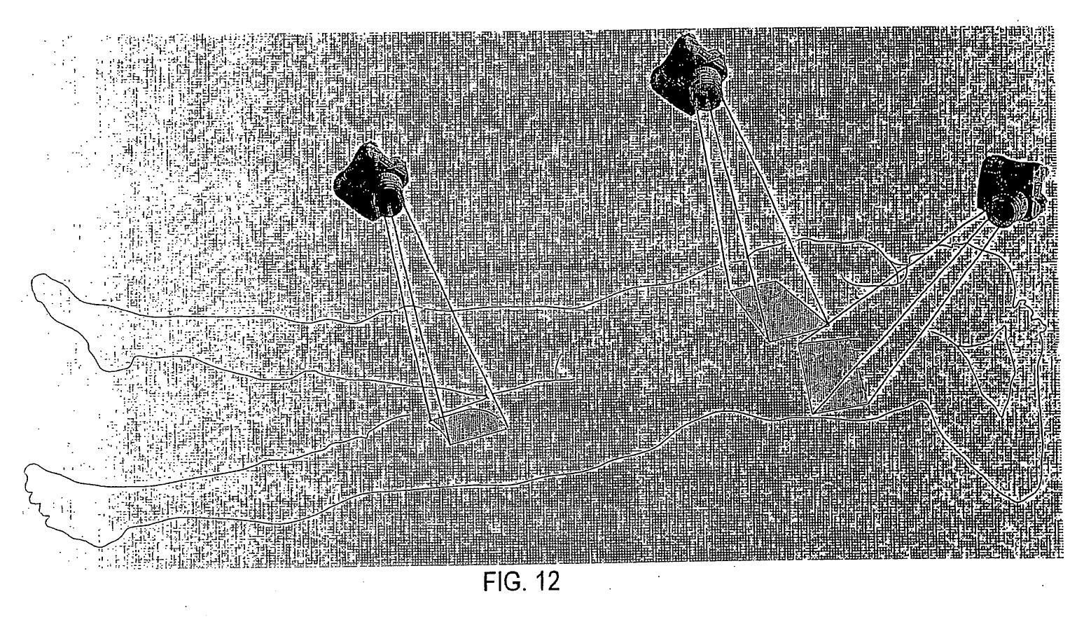

FIG. 12 is a three-dimensional view showing three different positions of the image collection means of FIG. 11 with respect to the body of the tested subject;

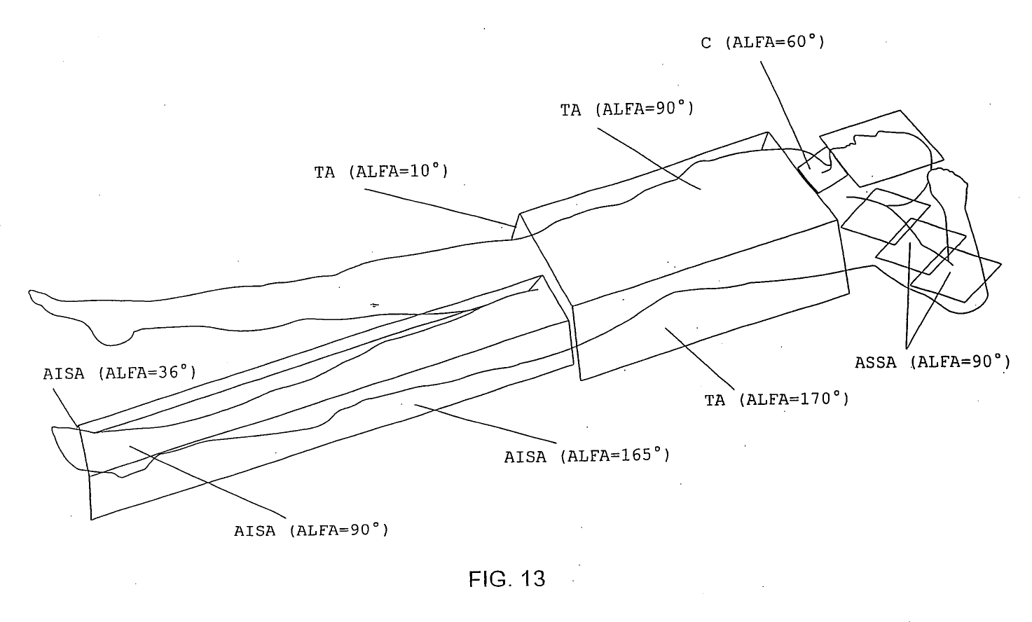

FIG. 13 is a view similar to the preceding one showing schematically some reference planes on which the frames of the collected images shown in FIGS. 6, 9 and 10 lie; and

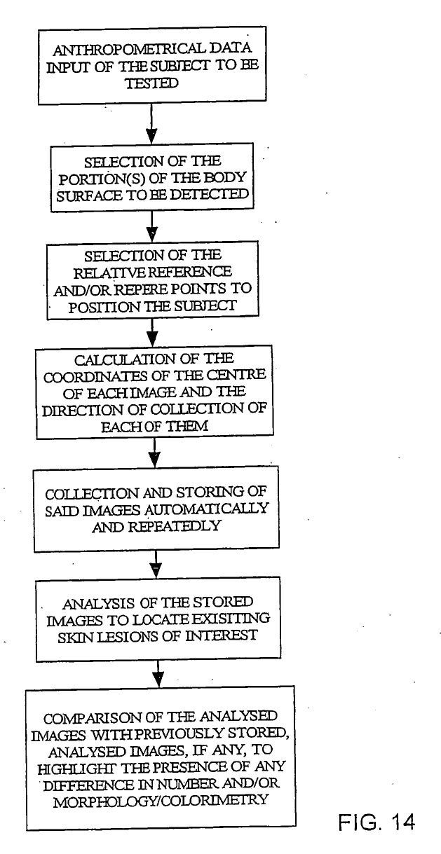

FIG. 14 is a block diagram showing the main steps of the method according to the present invention.

From the foregoing it is self-evident that according to the invention the photographic documentation of the skin state includes the whole body and not only some zones selected by the physician during the visit. In order to compare in time the lesions of interest, the collection of the images in subsequent tests is made so that the segmentation of the body provided by the single images is highly reproducible and the little, unavoidable variations of position of the tested subject are minimized until they are compatible with the existing technology.

Moreover, the images to be compared frequently include different “objects”: background portions, skin portions and, in some case, underwear portions. Furthermore, the skin portions can include in turn other “objects” besides the pigmentary lesions of interest: solar freckles, angioma, hairs, seborrheic keratosis, etc. Therefore, the automatic comparison of the images is carried out so as to eliminate any source of variability of the image content quite unconnected with the predetermined purposes (modifications of the background, underwear, different orientation of hairs, etc.).

It should be noted that even little modifications of the lighting can influence heavily the colorimetric characteristics of the lesions of interest detected in the images, thus forming a source of false alarms.

The condition necessary to carry out an automatic comparison of the images useful to the predetermined purposes is the suppression or minimization of any variation other than the detected one, i.e. the state of the pigmentary skin lesions of the same subject in time.

According to the present invention, in order to avoid the presence of false variations of the state of the above-mentioned lesions it is provided that:

1. each skin portion of the same subject is detected in subsequent times from a predetermined point of view which is unchanged with respect to the skin surface to be detected;

2. the position and orientation in the space of the camera (defined by Cartesian coordinates on three orthogonal axes X, Y, Z and angular values of the angles of rotation about Y axis (alpha) and Z axis (beta)) can be controlled and connected to the corresponding frame in a corresponding register file;

3. the tested subject is allowed to sit down to a position which is essentially unchanged in any following test;

4. the segmentation of the body into images is made so as to allow a comparison even when modifications of the body of the tested subject take place between subsequent tests.

To this end, the invention provides that the number of images collected for a determined patient is unchanged in the following image collections and that the images have partially overlapped edges to compensate any variation of dimension in the patient.

The distance of the body surface from the image collection means is generally constant and the orientation of such image collection means is predetermined for each image.

In order for the invention to be effective, it is necessary that numeric or morphological/colorimetric modifications of the pigmentary lesions (reset of the false negatives) are shown constantly and that the detection of any modification of other objects included in the compared images (suppression of the false positives) is minimized.

In case the body segmentation performed by the image collection system is absolutely reproducible (two images collected at a distance of time from each other reproducing exactly or almost exactly the same skin portion) as well as the images do not include other structures except for those of interest or other objects which are a source of confusing variations, the comparison is made by matching techniques with image subtraction.

In all of the other cases it is necessary to process the images before their comparison.

Such processing has two main purposes:
location of objects contained in the image other than skin (underwear, background, etc.) as well as structures that can produce false positives (hairs, spots produced by natural orifices or shadows, tattoos, etc.) with the purpose of ignoring them in the following comparison;
location of the lesions of interest to be compared.

As already mentioned above, the invention is directed to locate automatically the appearance even of only one new nevus or skin lesion of dermatological interest in all of the predefined body portions, for example from a minimum diameter of 2 millimetres on.

Moreover, the invention is able to detect, still automatically, a growth of the diameter of one or more of the previously mapped nevi equal for example to 1 millimetre.

To this end, the method of detection disclosed herein includes the following operating steps:
subdividing the body surface into quadrants with suitable size (FIG. 1);
selecting predetermined reference or “repere” points so that the following detection may have repere points able to collimate the body quadrants of the same subject;
collecting images with high definition relative to the above-mentioned quadrants;
locating, numbering and measuring all of the nevi or skin lesions present in each quadrant;
highlighting the new skin lesions in each quadrant and/or highlighting the morphological/colorimetric variations in one or more previously located skin lesions.

Such anatomic repere points are, for example, as follows: glabella, labial rima, umbilical jugulum, scapulo-humeral articulation, central point of the median line of cubital cavum, central point of the median line of the fore armpit, insertion of the second interdigital space of the hand, median point of the inguinal fold, lower gluteal fold, spinous eminence of the seventh cervical vertebra.

From a practical point of view, the invention provides an user-oriented apparatus which allows in short time (a few dozens of minutes with respect to many hours necessary in the known methods) people exposed to the risk of melanoma to be checked easily and with a high factor of reliability (for example +10% of false positives, and false negatives near zero).

To do so, the apparatus for carrying out such method includes a robot for driving the image collection means which is remote controlled with precision and reproducibility of its movements.

Moreover, such robot or apparatus for driving the image collection means is able to explore all of the body portions of a subject who is preferably placed in horizontal position on a litter.

The software for processing the collected images is able to measure shape and colour as well as dimension of growth (preferably at least 1 mm), to detect the onset of new skin lesions (for example from 2 mm on), to compare the morphologic and dimensional characteristics of each lesion in the same body portions collected in different times, even in case of little change of position of the tested subject and/or a body modification of the same.

More specifically, the invention provides an apparatus including in combination (FIGS. 1-5):
an application software for processing fine graphic data (skin lesions) provided with algorithms able to provide a discrete set of the detected images (matrices of calculation);
a data base for the statistic analysis of data of interest;
a data processing portion for clinic, personal data of the subjects for storing and listing the images of each patient upon his/her visiting (mode of the case history);
a reference surface S for the tested subject provided with anthropometrical references;
means for lighting uniformly without shadows the zones of the subject body surface to be detected;
image collection means 1;
means 2 for supporting and/or driving under control such image collection means 1 with respect to the patient;
interface means for controlling the data collection and transmission to suitable storing and/or processing means;
at least a computer connected to such interface means;
at least a high definition monitor or video or other display means of the known type;
means for controlling the correct positioning of the subject.

With particular reference to FIGS. 3, 4 and 5, it should be noted that the software disclosed above has a portion relative to the processing of the personal data of the tested subjects which respects of course the rules regarding the privacy and provides the anthropometrical data to define and calculate the coordinates of the selected frames: face, fore trunk, etc., so that they are proposed to the operator for their acceptance or modification before starting the data collection in the automatic mode.

Such portion relative to the privacy of the patient which will not be disclosed into detail makes use obviously of access password.

The SCANNING block illustrated in FIG. 4 arranges all of data necessary to the next step of effective PARAMETER SCANNING (FIG. 5).

According to the invention, all of data and images relative to the operations of SCANNING and PARAMETER SCANNING are stored so that they will be available for the next processing and/or comparison with data and images collected previously or subsequently.

The block ANALYSIS (FIG. 3) is arranged for the “cleaning” of the images collected from the objects not pertaining to the scanning performed, such as underwear, hairs, tattoos, other unconnected objects which would hamper a correct comparison able to locate all differences in the skin of the tested subject with respect to the preceding situation. Such cleaning operation is performed preferably by calculation routines of the known type in the field of graphic image processing.

It should also be noted that the portion of the software relative to the personal data processing of the subjects in case history mode is not necessary in itself for accomplishing the invention, however, it is indispensable to protect the privacy of the tested subjects. In fact it would be enough for the purposes of the invention to identify each subject by an univocal code (such as his/her fiscal code) to which the data base associates all data and images relative to the tested subject.

In the disclosed embodiment the block ANALYSIS performs the following operations:
recognizing not human pixels;
ablating piliferous appendages by parametrization software;
constructing grey levels referred to the weight of blue;
constructing the background (smoothing);
constructing levels of identification of the pigmented areas (spot objects);
calculating mathematically the evidence threshold;
recognizing the pigmented areas (spot objects);
characterizing the pigmented areas in terms of their specific qualities (spot objects);
differentiating the pigmented areas (spot objects) of the background noise (hair, underwear, tattoos, orifices, etc. objects).

Still in the disclosed embodiment, the block COMPARISON performs the following operations:
collimating frames (algorithm 1);
rotating/translating in scale;
calculating the known connections;
translating the pigmented areas (spot objects) to an assigned range to minimize the discards;

TABLE BSI

| | | | | Al- | | | |
|---|---|---|---|---|---|---|---|
| File Name | X | Y | Z | pha | Beta | Dlf | Drt |
| Image001.jpg | 901.95 | 387.54 | 228.23 | 90.00 | 0.00 | 51.72 | 53.84 |
| Image002.jpg | 970.42 | 308.86 | 244.02 | 90.00 | 0.00 | 54.02 | 51.84 |
| Image003.jpg | 1038.89 | 230.03 | 245.23 | 90.00 | 0.00 | 52.94 | 62.42 |

TABLE AIDP

| | | | | Al- | | | |
|---|---|---|---|---|---|---|---|
| File Name | X | Y | Z | pha | Beta | Dlf | Drt |
| Image001.jpg | 824.32 | 1035.74 | 178.50 | 90.00 | 0.00 | 55.70 | 50.70 |
| Image002.jpg | 822.07 | 1129.58 | 210.87 | 90.00 | 0.00 | 53.81 | 52.41 |
| Image003.jpg | 819.82 | 1223.57 | 228.41 | 90.00 | 0.00 | 53.42 | 52.47 |
| Image004.jpg | 817.57 | 1317.42 | 234.17 | 90.00 | 0.00 | 51.61 | 54.40 |
| Image005.jpg | 815.17 | 1411.26 | 215.68 | 90.00 | 0.00 | 51.94 | 54.34 |
| Image006.jpg | 813.06 | 1505.26 | 188.53 | 90.00 | 0.00 | 52.20 | 53.61 |
| Image007.jpg | 810.66 | 1599.10 | 188.05 | 90.00 | 0.00 | 71.22 | 52.96 |
| Image008.jpg | 808.41 | 1692.94 | 164.44 | 90.00 | 0.00 | 66.00 | 52.90 |
| Image009.jpg | 806.16 | 1786.94 | 102.40 | 90.00 | 0.00 | 65.90 | 52.71 |

TABLE C

| | | | | Al- | | | |
|---|---|---|---|---|---|---|---|
| File Name | X | Y | Z | pha | Beta | Dlf | Drt |
| Image001.jpg | 733.93 | 600.90 | 239.70 | 60.00 | 90.00 | 56.28 | 68.58 |

TABLE AIDA

| File Name | X | Y | Z | Alpha | Beta | Dlf | Drt |
|---|---|---|---|---|---|---|---|
| image001.jpg | 99.55 | 947.00 | 602.40 | 15.00 | 0.00 | 53.83 | 51.71 |
| image002.jpg | 101.95 | 1052.25 | 602.88 | 15.00 | 0.00 | 53.39 | 52.10 |
| image003.jpg | 127.63 | 1157.51 | 609.61 | 15.00 | 0.00 | 54.79 | 51.18 |
| image004.jpg | 135.29 | 1262.76 | 611.53 | 15.00 | 0.00 | 53.26 | 52.18 |
| image005.jpg | 159.16 | 1368.02 | 617.60 | 15.00 | 0.00 | 53.26 | 52.71 |
| image006.jpg | 164.71 | 1473.27 | 618.98 | 15.00 | 0.00 | 52.53 | 53.55 |
| image007.jpg | 177.18 | 1578.53 | 622.04 | 15.00 | 0.00 | 52.15 | 53.64 |
| image008.jpg | 164.26 | 1683.78 | 618.56 | 15.00 | 0.00 | 52.38 | 61.68 |
| image009.jpg | 199.55 | 1789.04 | 627.75 | 15.00 | 0.00 | 51.83 | 54.13 |
| image010.jpg | 678.83 | 1002.85 | 123.00 | 90.00 | 0.00 | 58.63 | 52.96 |
| image011.jpg | 679.43 | 1101.05 | 192.31 | 90.00 | 0.00 | 54.21 | 51.89 |
| image012.jpg | 680.03 | 1199.40 | 203.72 | 90.00 | 0.00 | 52.45 | 53.49 |
| image013.jpg | 680.78 | 1297.75 | 160.54 | 90.00 | 0.00 | 52.24 | 60.81 |
| image014.jpg | 681.38 | 1395.95 | 218.20 | 90.00 | 0.00 | 52.72 | 54.74 |
| image015.jpg | 682.13 | 1494.14 | 259.64 | 90.00 | 0.00 | 52.84 | 53.21 |
| image016.jpg | 682.73 | 1592.49 | 245.35 | 90.00 | 0.00 | 51.56 | 54.37 |
| image017.jpg | 683.33 | 1690.69 | 244.92 | 90.00 | 0.00 | 53.26 | 58.42 |
| image018.jpg | 683.93 | 1789.04 | 200.30 | 90.00 | 0.00 | 46.46 | 65.32 |
| Image019.jpg | 1222.22 | 1086.94 | 365.11 | 144.00 | 0.00 | 63.86 | 53.21 |
| Image020.jpg | 1136.19 | 1174.77 | 427.99 | 144.00 | 0.00 | 55.28 | 50.48 |
| Image021.jpg | 1119.37 | 1262.46 | 440.78 | 144.00 | 0.00 | 53.26 | 52.47 |
| Image022.jpg | 1111.11 | 1350.15 | 447.15 | 144.00 | 0.00 | 52.53 | 53.07 |
| Image023.jpg | 1094.89 | 1437.99 | 459.52 | 144.00 | 0.00 | 53.70 | 52.12 |
| Image024.jpg | 1094.44 | 1525.83 | 460.30 | 144.00 | 0.00 | 52.91 | 52.79 |
| Image025.jpg | 1104.05 | 1613.51 | 453.63 | 144.00 | 0.00 | 54.07 | 52.20 |
| Image026.jpg | 1102.85 | 1701.20 | 455.02 | 144.00 | 0.00 | 51.43 | 53.99 |
| Image027.jpg | 1112.31 | 1789.04 | 448.77 | 144.00 | 0.00 | 52.36 | 58.35 |

TABLE AISA

| File Name | X | Y | Z | Alpha | Beta | Dlf | Drt |
|---|---|---|---|---|---|---|---|
| Image001.jpg | 263.06 | 1086.94 | 367.21 | 36.00 | 0.00 | 62.40 | 52.88 |
| Image002.jpg | 356.46 | 1174.77 | 439.70 | 36.00 | 0.00 | 53.83 | 51.91 |
| Image003.jpg | 366.37 | 1262.46 | 451.29 | 36.00 | 0.00 | 53.14 | 52.88 |
| image004.jpg | 363.21 | 1350.15 | 453.69 | 36.00 | 0.00 | 53.52 | 52.63 |
| image005.jpg | 374.47 | 1437.99 | 466.19 | 36.00 | 0.00 | 52.79 | 52.55 |
| image006.jpg | 382.28 | 1525.68 | 476.58 | 36.00 | 0.00 | 52.74 | 53.41 |
| image007.jpg | 408.56 | 1613.51 | 500.12 | 36.00 | 0.00 | 56.41 | 50.74 |
| image008.jpg | 390.54 | 1701.20 | 491.47 | 36.00 | 0.00 | 55.11 | 52.20 |
| image009.jpg | 374.47 | 1789.04 | 484.44 | 36.00 | 0.00 | 60.04 | 52.90 |
| image010.jpg | 833.93 | 1023.72 | 174.65 | 90.00 | 0.00 | 53.73 | 52.10 |
| image011.jpg | 827.63 | 1119.37 | 181.44 | 90.00 | 0.00 | 53.68 | 52.23 |
| image012.jpg | 821.47 | 1215.02 | 181.62 | 90.00 | 0.00 | 53.55 | 52.55 |
| image013.jpg | 815.17 | 1310.66 | 181.14 | 90.00 | 0.00 | 50.80 | 55.05 |
| image014.jpg | 809.01 | 1406.46 | 225.59 | 90.00 | 0.00 | 53.91 | 52.28 |
| image015.jpg | 802.70 | 1501.95 | 206.37 | 90.00 | 0.00 | 54.91 | 50.86 |
| image016.jpg | 796.55 | 1597.75 | 255.08 | 90.00 | 0.00 | 62.53 | 53.01 |
| image017.jpg | 790.24 | 1693.24 | 240.18 | 90.00 | 0.00 | 63.45 | 52.96 |
| image018.jpg | 783.93 | 1789.04 | 277.48 | 90.00 | 0.00 | 55.16 | 55.59 |
| image019.jpg | 1402.70 | 978.23 | 612.73 | 165.00 | 0.00 | 54.43 | 51.16 |
| image020.jpg | 1383.33 | 1079.58 | 616.28 | 165.00 | 0.00 | 52.65 | 52.58 |
| image021.jpg | 1367.87 | 1180.93 | 618.74 | 165.00 | 0.00 | 53.11 | 52.31 |
| image022.jpg | 1345.95 | 1282.28 | 623.00 | 165.00 | 0.00 | 53.65 | 51.99 |
| image023.jpg | 1340.69 | 1383.63 | 622.76 | 165.00 | 0.00 | 53.19 | 52.63 |
| image024.jpg | 1354.35 | 1484.98 | 617.48 | 165.00 | 0.00 | 50.39 | 54.95 |
| image025.jpg | 1361.26 | 1586.34 | 613.87 | 165.00 | 0.00 | 89.00 | 52.52 |
| image026.jpg | 1332.13 | 1687.69 | 620.06 | 165.00 | 0.00 | 56.95 | 50.39 |
| image027.jpg | 1322.67 | 1789.04 | 620.90 | 165.00 | 0.00 | 53.26 | 51.46 |

TABLE AISP

| | | | | Al- | | | |
|---|---|---|---|---|---|---|---|
| File Name | X | Y | Z | pha | Beta | Dlf | Drt |
| Image001.jpg | 633.93 | 1013.51 | 123.90 | 90.00 | 0.00 | 59.47 | 53.10 |
| Image002.jpg | 633.93 | 1110.21 | 221.92 | 90.00 | 0.00 | 51.63 | 49.27 |
| Image003.jpg | 633.93 | 1206.91 | 212.13 | 90.00 | 0.00 | 52.89 | 53.24 |
| Image004.jpg | 633.93 | 1303.60 | 227.39 | 90.00 | 0.00 | 52.74 | 53.61 |
| Image005.jpg | 633.93 | 1400.30 | 220.12 | 90.00 | 0.00 | 52.20 | 54.13 |
| Image006.jpg | 633.93 | 1496.85 | 222.58 | 90.00 | 0.00 | 51.67 | 54.16 |
| Image007.jpg | 633.93 | 1593.54 | 222.28 | 90.00 | 0.00 | 52.43 | 53.93 |
| Image008.jpg | 633.93 | 1690.24 | 177.84 | 90.00 | 0.00 | 52.84 | 67.32 |
| Image009.jpg | 633.93 | 1786.94 | 232.31 | 90.00 | 0.00 | 52.01 | 55.30 |

TABLE ASDA

| | | | | Al- | | | |
|---|---|---|---|---|---|---|---|
| File Name | X | Y | Z | pha | Beta | Dlf | Drt |
| Image001.jpg | 20.87 | 449.25 | 637.06 | 10.00 | 0.00 | 52.84 | 60.08 |
| Image002.jpg | 25.98 | 541.89 | 638.50 | 10.00 | 0.00 | 52.67 | 53.32 |
| image003.jpg | 33.48 | 634.53 | 640.18 | 10.00 | 0.00 | 52.38 | 53.58 |
| image004.jpg | 28.08 | 727.03 | 639.76 | 10.00 | 0.00 | 53.14 | 52.77 |
| image005.jpg | 19.67 | 819.67 | 638.62 | 10.00 | 0.00 | 54.26 | 51.73 |
| image006.jpg | 15.62 | 912.16 | 638.44 | 10.00 | 0.00 | 53.01 | 52.41 |
| image007.jpg | 4.80 | 1004.95 | 636.82 | 10.00 | 0.00 | 52.79 | 51.58 |
| image008.jpg | 44.29 | 1097.45 | 644.26 | 10.00 | 0.00 | 55.19 | 50.77 |
| image009.jpg | 573.57 | 449.25 | 176.10 | 90.00 | 0.00 | 53.06 | 65.27 |
| image010.jpg | 571.17 | 541.89 | 178.50 | 90.00 | 0.00 | 54.40 | 51.63 |
| image011.jpg | 568.62 | 634.53 | 200.00 | 90.00 | 0.00 | 53.97 | 52.15 |
| image012.jpg | 566.07 | 727.03 | 196.40 | 90.00 | 0.00 | 53.65 | 52.41 |
| image013.jpg | 563.51 | 819.67 | 199.46 | 90.00 | 0.00 | 51.13 | 55.08 |
| image014.jpg | 560.96 | 912.16 | 181.14 | 90.00 | 0.00 | 50.84 | 55.02 |
| image015.jpg | 558.56 | 1004.95 | 160.36 | 90.00 | 0.00 | 53.01 | 52.47 |
| image016.jpg | 556.01 | 1097.45 | 156.04 | 90.00 | 0.00 | 67.26 | 52.88 |

TABLE ASDI

| | | | | Al- | | | |
|---|---|---|---|---|---|---|---|
| File Name | X | Y | Z | pha | Beta | Dlf | Drt |
| Image001.jpg | 433.18 | 637.69 | 230.75 | 90.00 | 0.00 | 51.63 | 54.25 |
| Image002.jpg | 360.96 | 737.54 | 202.76 | 90.00 | 0.00 | 54.91 | 50.96 |
| Image003.jpg | 288.74 | 837.24 | 227.39 | 90.00 | 0.00 | 52.91 | 61.81 |
| Image004.jpg | 216.52 | 937.09 | 210.27 | 90.00 | 0.00 | 56.31 | 52.33 |

TABLE ASDP

| | | | | Al- | | | |
|---|---|---|---|---|---|---|---|
| File Name | X | Y | Z | pha | Beta | Dlf | Drt |
| Image001.jpg | 935.44 | 410.36 | 190.45 | 90.00 | 0.00 | 51.15 | 57.59 |
| Image002.jpg | 938.74 | 508.86 | 202.88 | 90.00 | 0.00 | 53.11 | 58.17 |
| Image003.jpg | 942.19 | 607.51 | 224.86 | 90.00 | 0.00 | 50.96 | 55.36 |
| Image004.jpg | 945.65 | 706.16 | 234.65 | 90.00 | 0.00 | 54.59 | 51.56 |
| Image005.jpg | 949.10 | 804.65 | 258.32 | 90.00 | 0.00 | 55.64 | 51.21 |
| Image006.jpg | 952.55 | 903.15 | 238.74 | 90.00 | 0.00 | 51.45 | 54.34 |
| Image007.jpg | 955.86 | 1001.80 | 266.13 | 90.00 | 0.00 | 53.09 | 52.82 |

TABLE ASSP

| | | | | Al- | | | |
|---|---|---|---|---|---|---|---|
| File Name | X | Y | Z | pha | Beta | Dlf | Drt |
| image001.jpg | 537.09 | 441.14 | 171.47 | 90.00 | 0.00 | 52.77 | 75.39 |
| image002.jpg | 535.44 | 541.44 | 206.19 | 90.00 | 0.00 | 51.85 | 54.34 |
| image003.jpg | 533.63 | 641.74 | 226.07 | 90.00 | 0.00 | 53.57 | 52.63 |
| image004.jpg | 532.13 | 742.04 | 243.06 | 90.00 | 0.00 | 54.37 | 51.46 |
| image005.jpg | 530.33 | 842.34 | 298.86 | 90.00 | 0.00 | 55.31 | 50.86 |
| image006.jpg | 528.68 | 942.79 | 263.66 | 90.00 | 0.00 | 53.37 | 52.18 |
| image007.jpg | 527.03 | 1043.09 | 322.88 | 90.00 | 0.00 | 53.94 | 51.89 |

TABLE ASSA

| File Name | X | Y | Z | Alpha | Beta | Dlf | Drt |
|---|---|---|---|---|---|---|---|
| Image001.jpg | 896.85 | 427.03 | 166.19 | 90.00 | 0.00 | 52.91 | 64.51 |
| Image002.jpg | 906.46 | 515.77 | 139.22 | 90.00 | 0.00 | 52.84 | 59.80 |
| Image003.jpg | 916.07 | 604.35 | 196.88 | 90.00 | 0.00 | 52.13 | 53.78 |
| Image004.jpg | 925.53 | 692.94 | 168.71 | 90.00 | 0.00 | 52.45 | 59.25 |
| image005.jpg | 935.14 | 781.53 | 221.32 | 90.00 | 0.00 | 53.26 | 50.96 |
| image006.jpg | 944.74 | 870.27 | 209.55 | 90.00 | 0.00 | 52.48 | 53.38 |
| image007.jpg | 954.35 | 958.86 | 207.93 | 90.00 | 0.00 | 52.48 | 53.46 |
| image008.jpg | 963.96 | 1047.45 | 236.10 | 90.00 | 0.00 | 52.84 | 53.21 |
| image009.jpg | 1439.34 | 427.03 | 620.84 | 170.00 | 0.00 | 52.69 | 75.00 |
| image010.jpg | 1427.18 | 515.62 | 624.74 | 170.00 | 0.00 | 51.97 | 53.27 |
| image011.jpg | 1456.61 | 604.35 | 621.14 | 170.00 | 0.00 | 66.44 | 52.77 |
| image012.jpg | 1445.20 | 692.94 | 624.86 | 170.00 | 0.00 | 54.02 | 51.94 |
| image013.jpg | 1440.69 | 781.53 | 627.27 | 170.00 | 0.00 | 64.36 | 53.04 |
| image014.jpg | 1476.43 | 870.27 | 622.70 | 170.00 | 0.00 | 61.72 | 52.77 |
| image015.jpg | 1458.11 | 958.86 | 627.63 | 170.00 | 0.00 | 53.34 | 51.76 |
| image016.jpg | 1432.88 | 1047.45 | 633.87 | 170.00 | 0.00 | 54.02 | 51.38 |

TABLE ASSI

| | | | | Al- | | | |
|---|---|---|---|---|---|---|---|
| File Name | X | Y | Z | pha | Beta | Dlf | Drt |
| Image001.jpg | 1015.32 | 671.92 | 209.79 | 90.00 | 0.00 | 53.73 | 52.44 |
| Image002.jpg | 1077.78 | 777.18 | 233.39 | 90.00 | 0.00 | 62.70 | 53.32 |
| Image003.jpg | 1140.24 | 882.43 | 265.77 | 90.00 | 0.00 | 58.48 | 53.24 |
| Image004.jpg | 1202.70 | 987.69 | 230.15 | 90.00 | 0.00 | 59.58 | 53.04 |

TABLE BDI

| | | | | Al- | | | |
|---|---|---|---|---|---|---|---|
| File Name | X | Y | Z | pha | Beta | Dlf | Drt |
| image001.jpg | 562.31 | 397.75 | 209.67 | 90.00 | 0.00 | 53.06 | 59.84 |
| image002.jpg | 499.40 | 321.17 | 257.12 | 90.00 | 0.00 | 51.30 | 54.71 |
| image003.jpg | 436.49 | 244.74 | 211.53 | 90.00 | 0.00 | 52.53 | 65.51 |

TABLE DP

| File Name | X | Y | Z | Alpha | Beta | Dlf | Drt |
|---|---|---|---|---|---|---|---|
| Image001.- | 669.37 | 1406.61 | 321.44 | 140.00 | 90.00 | 61.60 | 88.16 |
| jpg | | | | | | | |
| Image002.- | 817.87 | 1406.61 | 321.44 | 140.00 | 90.00 | 70.30 | 66.35 |
| jpg | | | | | | | |

TABLE RA

| File Name | X | Y | Z | Alpha | Beta | Dlf | Drt |
|---|---|---|---|---|---|---|---|
| Image001.jpg | 733.93 | 1038.29 | 80.00 | 90.00 | 0.00 | 64.36 | 56.44 |

TABLE SDP

| File Name | X | Y | Z | Alpha | Beta | Dlf | Drt |
|---|---|---|---|---|---|---|---|
| Image001.jpg | 1131.53 | 21.77 | 604.02 | 165.00 | 50.00 | 49.21 | 54.77 |

TABLE FA

| File Name | X | Y | Z | Alpha | Beta | Dlf | Drt |
|---|---|---|---|---|---|---|---|
| Image001.jpg | 120.57 | 438.74 | 586.67 | 10.00 | 0.00 | 52.89 | 66.20 |
| Image002.jpg | 145.50 | 525.38 | 590.87 | 10.00 | 0.00 | 50.73 | 55.33 |
| Image003.jpg | 127.93 | 612.01 | 587.93 | 10.00 | 0.00 | 51.09 | 54.74 |
| Image004.jpg | 123.72 | 698.65 | 587.27 | 10.00 | 0.00 | 52.91 | 52.41 |
| Image005.jpg | 128.53 | 785.29 | 588.05 | 10.00 | 0.00 | 53.86 | 52.10 |
| Image006.jpg | 124.17 | 871.92 | 587.27 | 10.00 | 0.00 | 50.43 | 56.21 |
| Image007.jpg | 1368.92 | 438.74 | 597.72 | 170.00 | 0.00 | 52.01 | 61.73 |
| Image008.jpg | 1362.46 | 525.38 | 598.92 | 170.00 | 0.00 | 53.31 | 52.12 |
| Image009.jpg | 1364.11 | 612.01 | 598.62 | 170.00 | 0.00 | 52.06 | 53.18 |
| Image010.jpg | 1369.37 | 698.65 | 597.60 | 170.00 | 0.00 | 52.03 | 53.10 |
| Image011.jpg | 1361.11 | 785.29 | 599.10 | 170.00 | 0.00 | 53.44 | 52.10 |
| Image012.jpg | 1383.78 | 871.92 | 595.08 | 170.00 | 0.00 | 51.56 | 53.27 |

TABLE FP

| File Name | X | Y | Z | Alpha | Beta | Dlf | Drt |
|---|---|---|---|---|---|---|---|
| image001.jpg | 70.27 | 367.72 | 577.72 | 10.00 | 0.00 | 52.60 | 68.80 |
| image002.jpg | 108.26 | 460.96 | 584.44 | 10.00 | 0.00 | 50.49 | 55.81 |
| image003.jpg | 103.15 | 554.20 | 583.48 | 10.00 | 0.00 | 53.89 | 51.84 |
| image004.jpg | 124.77 | 647.45 | 587.33 | 10.00 | 0.00 | 53.26 | 52.63 |
| image005.jpg | 123.27 | 740.69 | 587.15 | 10.00 | 0.00 | 51.56 | 54.89 |
| image006.jpg | 85.29 | 833.93 | 580.42 | 10.00 | 0.00 | 52.36 | 59.45 |
| image007.jpg | 1437.54 | 367.72 | 599.52 | 170.00 | 0.00 | 52.72 | 66.61 |
| image008.jpg | 1470.42 | 460.96 | 593.81 | 170.00 | 0.00 | 59.06 | 52.79 |
| image009.jpg | 1405.86 | 554.20 | 605.11 | 170.00 | 0.00 | 53.57 | 51.43 |
| image010.jpg | 1378.68 | 647.45 | 609.91 | 170.00 | 0.00 | 53.34 | 51.76 |
| image011.jpg | 1383.78 | 740.69 | 609.01 | 170.00 | 0.00 | 52.69 | 52.39 |
| image012.jpg | 1379.13 | 833.93 | 609.85 | 170.00 | 0.00 | 52.74 | 52.18 |

TABLE SSA

| File Name | X | Y | Z | Alpha | Beta | Dlf | Drt |
|---|---|---|---|---|---|---|---|
| Image001.jpg | 1131.53 | 21.77 | 604.02 | 165.00 | 50.00 | 48.50 | 53.38 |

TABLE V

| File Name | X | Y | Z | Alpha | Beta | Dlf | Drt |
|---|---|---|---|---|---|---|---|
| Image001.- | 177.48 | 207.06 | 577.60 | 10.00 | 0.00 | 53.49 | 53.04 |
| jpg | | | | | | | |
| Image002.- | 100.90 | 322.37 | 564.20 | 10.00 | 0.00 | 63.41 | 52.77 |
| jpg | | | | | | | |
| Image003.- | 733.93 | 207.06 | 123.36 | 90.00 | 0.00 | 52.77 | 61.47 |
| jpg | | | | | | | |
| Im-age004. | 733.93 | 322.37 | 126.07 | 90.00 | 0.00 | 53.99 | 51.99 |
| jpg | | | | | | | |
| Image005.- | 1273.42 | 207.06 | 580.54 | 170.00 | 0.00 | 53.16 | 88.16 |
| jpg | | | | | | | |
| Image006.- | 1256.61 | 322.37 | 583.54 | 170.00 | 0.00 | 52.48 | 53.75 |
| jpg | | | | | | | |

TABLE TA

| | | | | Al- | | | |
|---|---|---|---|---|---|---|---|
| File Name | X | Y | Z | pha | Beta | Dlf | Drt |
| Image001.jpg | 633.93 | 438.74 | 155.20 | 90.00 | 0.00 | 53.16 | 75.45 |
| Image002.jpg | 633.93 | 525.38 | 101.68 | 90.00 | 0.00 | 52.94 | 60.12 |
| Image003.jpg | 633.93 | 612.01 | 112.49 | 90.00 | 0.00 | 52.10 | 54.04 |
| Image004.jpg | 633.93 | 698.65 | 113.99 | 90.00 | 0.00 | 56.00 | 50.77 |
| Image005.jpg | 633.93 | 785.29 | 141.14 | 90.00 | 0.00 | 55.22 | 50.79 |
| Image006.jpg | 633.93 | 871.92 | 154.53 | 90.00 | 0.00 | 53.68 | 51.63 |
| Image007.jpg | 733.93 | 438.74 | 128.65 | 90.00 | 0.00 | 53.68 | 51.94 |
| Image008.jpg | 733.93 | 525.38 | 126.43 | 90.00 | 0.00 | 52.57 | 53.41 |
| Image009.jpg | 733.93 | 612.01 | 123.30 | 90.00 | 0.00 | 53.04 | 53.10 |
| Image010.jpg | 733.93 | 698.65 | 105.59 | 90.00 | 0.00 | 54.85 | 51.51 |
| Image011.jpg | 733.93 | 785.29 | 111.89 | 90.00 | 0.00 | 54.62 | 51.46 |
| Image012.jpg | 733.93 | 871.92 | 128.29 | 90.00 | 0.00 | 54.79 | 51.63 |
| Image013.jpg | 833.93 | 438.74 | 167.81 | 90.00 | 0.00 | 51.63 | 54.40 |
| Image014.jpg | 833.93 | 525.38 | 157.12 | 90.00 | 0.00 | 51.24 | 54.83 |
| Image015.jpg | 833.93 | 612.01 | 107.81 | 90.00 | 0.00 | 53.06 | 62.37 |
| Image016.jpg | 833.93 | 698.65 | 155.50 | 90.00 | 0.00 | 53.37 | 52.60 |
| Image017.jpg | 833.93 | 785.29 | 153.99 | 90.00 | 0.00 | 54.71 | 51.13 |
| Image018.jpg | 833.93 | 871.92 | 167.39 | 90.00 | 0.00 | 52.29 | 53.78 |

TABLE TP

| | | | | Al- | | | |
|---|---|---|---|---|---|---|---|
| File Name | X | Y | Z | pha | Beta | Dlf | Drt |
| image001.jpg | 633.93 | 367.72 | 129.67 | 90.00 | 0.00 | 53.16 | 78.63 |
| image002.jpg | 633.93 | 460.96 | 132.19 | 90.00 | 0.00 | 52.50 | 53.61 |
| image003.jpg | 633.93 | 554.20 | 128.95 | 90.00 | 0.00 | 54.05 | 51.71 |
| image004.jpg | 633.93 | 647.45 | 145.29 | 90.00 | 0.00 | 53.65 | 51.33 |
| image005.jpg | 633.93 | 740.69 | 137.78 | 90.00 | 0.00 | 54.10 | 52.41 |
| image006.jpg | 633.93 | 833.93 | 134.17 | 90.00 | 0.00 | 51.92 | 54.04 |
| image007.jpg | 733.93 | 367.72 | 110.75 | 90.00 | 0.00 | 54.57 | 51.58 |
| image008.jpg | 733.93 | 460.96 | 132.79 | 90.00 | 0.00 | 51.00 | 52.07 |
| image009.jpg | 733.93 | 554.20 | 115.80 | 90.00 | 0.00 | 53.62 | 52.20 |
| image010.jpg | 733.93 | 647.45 | 132.91 | 90.00 | 0.00 | 54.91 | 51.18 |
| image011.jpg | 733.93 | 740.69 | 151.41 | 90.00 | 0.00 | 54.13 | 51.79 |
| image012.jpg | 733.93 | 833.93 | 140.00 | 90.00 | 0.00 | 51.65 | 54.25 |
| image013.jpg | 833.93 | 367.72 | 125.77 | 90.00 | 0.00 | 53.24 | 74.50 |
| image014.jpg | 833.93 | 460.96 | 137.60 | 90.00 | 0.00 | 52.36 | 54.10 |
| Image015.jpg | 833.93 | 554.20 | 137.30 | 90.00 | 0.00 | 53.99 | 52.04 |
| Image016.jpg | 833.93 | 647.45 | 158.44 | 90.00 | 0.00 | 53.83 | 52.77 |
| Image017.jpg | 833.93 | 740.69 | 164.44 | 90.00 | 0.00 | 51.97 | 53.24 |
| Image018.jpg | 833.93 | 833.93 | 150.57 | 90.00 | 0.00 | 51.26 | 54.65 |

It is evident from the foregoing according to the invention that it is possible to detect a given portion of the body surface always in the same position and with the same inclination. To do so, in fact, it is provided that the subject is allowed to sit down in the following sessions always in the same position with respect to the above-mentioned reference anthropometrical points.

To this end, the invention provides a suitable control means for the correct repositioning of the subject which in the present embodiment illustrated by way of a not limiting example consists of laser beam projectors also performing the function of allowing the automatic focusing of the image collection means. In the embodiment illustrated in FIG. 11, such laser projectors are placed at the upper and lower sides of such image collection means. According to the invention the repositioning of the tested subject is precise enough when the light beams produced by such laser projectors coincide to one spot at the predetermined repere point.

The present invention has been described and illustrated according to a preferred embodiment thereof, however, it is self-evident that anyone skilled in the art can make modifications and/or technically and functionally equivalent replacements without departing from the scope of the present industrial invention.

### BIBLIOGRAPHY

[1]. Oliveira S A, Christos P J et al.; Clin Epidemiol 1999 November; 52: 1111-6.
[2]. Richard M A, Grob J J et al.; Int J Cancer 2000 May; 20: 280-5.
[3]. Muhn C Y et al.; J Am Acad Dermatol 2000 May; 42:754-9.
[4]. Hanrahan P F, Hersey et al. Arch Dermatol 1997 March; 133: 301-11.

1-18. (canceled)

19. A method of detecting and showing variations in the number and/or the morphology of the external skin lesions of dermatological interest, characterized in that in order to automate the detection and the transmission of said variations digital images of the body surface of the tested subject are collected after having divided the latter into one or more areas exactly located by means of spatial coordinates in a system of coordinated axes fixed with respect to predetermined unchanged reference points of the subject, the images being stored in a suitable data base to be then compared automatically with corresponding images collected at distance of time, thus producing a signal of any variation in the number and/or the morphology/colour of the lesions; the relative spatial position between the subject body surface and the point of view from which said images are collected being the same for each subsequent corresponding image.

20. The method according to claim 19, characterized in that there are provided the following operating steps:
A. subdividing the body surface into quadrants with suitable size;
B. selecting predetermined reference or “repere” anatomic points so that the following detection may have repere points able to collimate the body quadrants of the same subject;
C. collecting and storing images with high definition relative to the above-mentioned quadrants;
D. processing the stored images to perform the following operations:
locating, numbering and measuring all of the skin lesions present in each quadrant;
storing images and data relative to said skin lesions;
if the subject is not a new subject, comparing collected images and corresponding data with previously stored images and data of the same subject;
highlighting and/or transmitting the new skin lesions in each quadrant and/or highlighting the morphological/colorimetric variations in one or more previously located skin lesions;
storing data relative to the detected differences.

21. The method according to claim 19, characterized in that there are provided the following steps:
a) inputting anthropometrical data of the subject to be tested;
b) selecting the portion(s) of the body surface to be detected;
c) positioning the subject on the basis of the predetermined reference and/or repere points;
d) calculating the coordinates of the center of each image and the direction of collection of each of them;
e) collecting and storing said images automatically and repeatedly;
f) analyzing the stored images to locate the existing skin lesions of interest;
g) comparing the analysed images with the images stored and analysed previously, if any, to highlight the presence of any numeric and/or calorimetric difference

22. The method according to claim 20, characterized in that said processing or analysis of the stored images provides essentially:
locating objects contained in the image other than skin (underwear, background, etc.);
locating structures that can produce false positives (hairs, spots produced by natural orifices or shadows, tattoos, etc.); and
locating lesions of interest to be compared and ignoring objects and/or structures of the two preceding items.

23. The method according to claim 19, characterized in that in order for any variation of the collected images not relating the state of the skin lesions to be suppressed or minimized, it is provided that each skin portion of the same subject is detected in subsequent times from a predetermined and fixed point of view, or that the spatial positions of the detection apparatus and the tested subject (or his/her skin portion) are constant.

24. The method according to claim 23, characterized in that the tested subject is allowed to sit down to essentially the same position in any test following the first.

25. The method according to claim 23, characterized in that the body surface of tested subject is segmented or sub-divided into images is performed so that the edges of the images are partially overlapped so as to allow a comparison even when modifications of the body of the tested subject take place between subsequent tests.

26. The method according to claim 25, characterized in that the number of collected images for a determined patient is always the same, even if the patient increase in weight and/or height in time.

27. The method according to claim 19, characterized in that the patient is illuminated uniformly and from different angles so as to avoid portions in the shade at the areas to be detected.

28. The method according to claim 21, characterized in that step f) of image analysis includes the following steps:
recognizing not human pixels;
ablating piliferous appendages by parametrization software;
constructing grey levels referred to the weight of blue;
constructing the background (smoothing);
constructing levels of identification of the pigmented areas (spot objects);
calculating mathematically the evidence threshold;
recognizing the pigmented areas (spot objects);
characterizing the pigmented areas in terms of their specific qualities (spot objects);
differentiating the pigmented areas (spot objects) of the background noise (hair, underwear, tattoos, orifices, etc. objects).

29. The method according to claim 21, characterized in that step g) of image comparison includes the following steps:
collimating frames (algorithm 1);
rotating/translating in scale;
calculating the known connections;
translating the pigmented areas (spot objects) to an assigned range to minimize the discards;
calculating the differences (minus and/or plus dimensional-variation of the inner colour);
optimizing: if the number of erroneous connections is greater than three of or if the secondary translation of the pigmented areas (spot objects) is grater than an assigned level (for example 100 pixels), a second collimation method (algorithm 2) is performed.

30. An apparatus for detecting images by the method according to claim 19, characterized in that there is provided in combination:
a) an application software for processing fine graphic data (skin lesions) provided with algorithms able to provide a discrete set of the detected images (matrices of calculation);
b) a data base for the statistic analysis of data of interest;
c) a data processing portion for clinical, personal data of the subjects for storing and listing the images of each patient upon his/her visiting (mode of the case history);
d) a reference surface provided with anthropometrical references with respect to which the tested subject is positioned;
e) means for lighting uniformly without shadows the zones of the subject body surface to be detected;
f) image collection means
g) means for supporting and/or driving under control such image collection means with respect to the patient;
h) interface means for controlling the data collection and transmission to suitable storing and/or processing means;
i) at least a computer connected to such interface means;
j) at least a high definition monitor or video or other display means of the know type;
k) means for controlling the correct repositioning of the subject.
Said means for supporting and/or driving said image collection means being controlled so as the relative spatial position of the subject body surface and the point of view from which the images are collected are the same for each subsequent corresponding image.

31. The apparatus according to claim 30, characterized in that said anthropometrical references located in the reference surface for positioning the subject are able to locate the repere points which are significant for different somatic types as well as for the same patient subjected to several next detections so that defined, significant body areas that can be overlapped are obtained to guarantee a correct collimation of the collected images.

32. The apparatus according to claim 31, characterized in that it is provided with a computer, controlled by an assistant, which controls and manages the apparatus in a completely automatic way.

33. The apparatus according to claim 30, characterized in that said support and drive means of the image collection means is able to position the latter perpendicular to the area of the body surface to be detected and at a constant distance therefrom.

34. The apparatus according to claim 30, characterized in that it is provided with storing means which store the position and the orientation taken by said image collection means for each collected image, during the first session so that corresponding images are collected in the following sessions exactly with the same position and orientation, thus providing following images perfectly corresponding and comparable with those of the preceding session.

35. The apparatus according to claim 30, characterized in that it is provided with calculating means which calculate the positions of the images to be collected, so that the edges of images adjacent to one another are partially surmounted, thus forming an overlap.

36. The apparatus according to claim 35, characterized in that the overlap of the image edges adjacent to one another varies preferably from a maximum equal to half the height and half the width of the image to a minimum that can be zero (images with coincident edges).
